(19) United States
(12) Patent Application Publication
(10) Pub. No.: US 2008/0219105 A1
(43) Pub. Date: Sep. 11, 2008

(54) Al zimuth Christian meter with formula, and tables

(76) Inventor: Julian Franciscus Vaughn, Altoona, PA (US)

Correspondence Address: Julian Franciscus Vaughn, # 714, 1010 12th St., Altoona, PA, 16601, US

(21) Appl. No.: 11/818,959

(22) Filed: Mar. 5, 2007

(51) Int. Cl. G04B 19/00

(52) U.S. Cl. 368/223

(57) ABSTRACT

This invention is a Mathematical Formula, T=d/p, and corresponding tables, that are meant to initiate a manual Method of Process. This process is intended to meter the time differential between the LORDS 360 degree Day, vs. Mans 360 degree Day. Sort of like a shot clock in basketball, vs the basketball game clock. The method is used to acquire exact information concerning ones inquiries concerning the time differential between these two ‘Days’.

I, Julian Franciscus Vaughn, have invented a new method of process, mathematical formula and corresponding table in which to meter the time differential between the LORDS DAY vs Mans DAY, as set forth in the following specification. These works are copyrighted as visual art, and text entitled Al Zimuth Christian Meter. So I am including notice of this work in accordance with CFR 37 171(e). The method of making and using this device is simple. The Meter Face can be made using basic photocopy technology, and the dials can be moved manually, using the medium of traditional chronological media using my formulas and tables as guidelines. The dials themselves can be fixed in position for turning, over basic plastic, by the method of pinning. This in effect enabling one skilled in the art to which this pertains, to make it, even in the case of further improvement in the future.

The claimed method of process, formulae, and tables are used to meter the time differential between the LORDS 24 hr day vs Mans 24 hr day, as spake by St. Peter in 2 Peter 3:8. The Meter Face is a Graph/Table, metering the passage of time in increments of degrees. This allows for two main hands to measure one time vs the other.

There is a corresponding mathematical formula, and table that work with the meter face. This formula is the result of the degree markings as they relate to the method of process. The first table displays the conversion rate from degrees to years for the LORDS DAY HAND. The second table displays the conversion rate from degrees to minutes for the Mans DAY HAND.

These calculations become useful to the Christian who desires to meter the time differential between the LORDS dimension vs our own. The benefit comes mostly in prayer and supplication. The Christian using these calculations would realize that 1 minute of the LORDS day or 0.25 degrees of movement of the LORDS DAY HAND equals 0.694444 years on Earth, or approximately 8 months Earth time, and so on, with these calculations. The result would be more diligent prayer by the Christian, increasing the believers presence in this other dimension. This also would instill a sense of GOD the Father of our Lord and Saviour Jesus Christs' longsuffering in the believer. This giving the believer a(n) understanding of why things take so long, the believer now having access to a clear display of The LORDS DAY vs Mans Day.

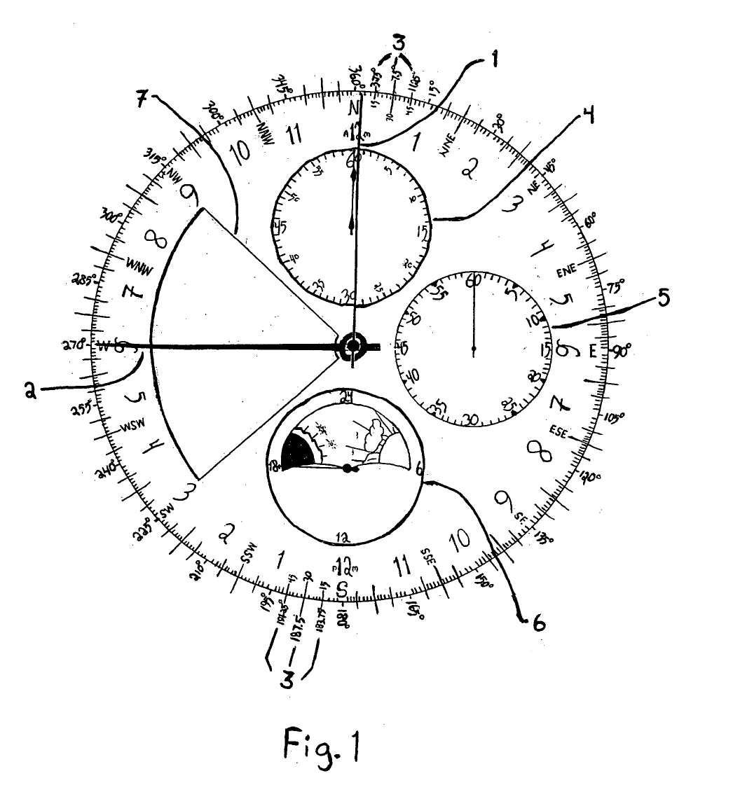

FIG. 1 is a front view of a meter face showing my new method of process for metering the time differential between the LORDS DAY vs Mans DAY;
1. is the Hand displaying the LORDS DAY movement, which moves 0.25 degrees per 0.68444 years. (approx 8 mos);
2. is the Hand displaying Mans DAY movement, which moves 0.25 degrees per minute.
3. is the degree markings per ¼ hour, equaling 3.75 degrees per 15 minutes, 7.50 degrees per 30 minutes, 11.25 degrees per 45 minutes, and 15 degrees per hour;
4. is the Dial displaying seconds per minute in Mans DAY;
5. is the Dial displaying minutes per hours in Mans DAY;
6. is the Dial displaying hours per day in Mans DAY;
7. is a space on the meter face meant for LCD readouts for the LORDS DAY time in Hrs, Min, Sec, Kiloseconds, Miloseconds, Nanoseconds, and Picoseconds;

FIG. 2. is a presentation of the mathematical formula which this process is based upon. The formula is T=D/M, or Time equals Degrees over Minutes. This formula extends, though, to Picoseconds, showing a final formula of T=D/P, or Time equals Degrees over Picoseconds;

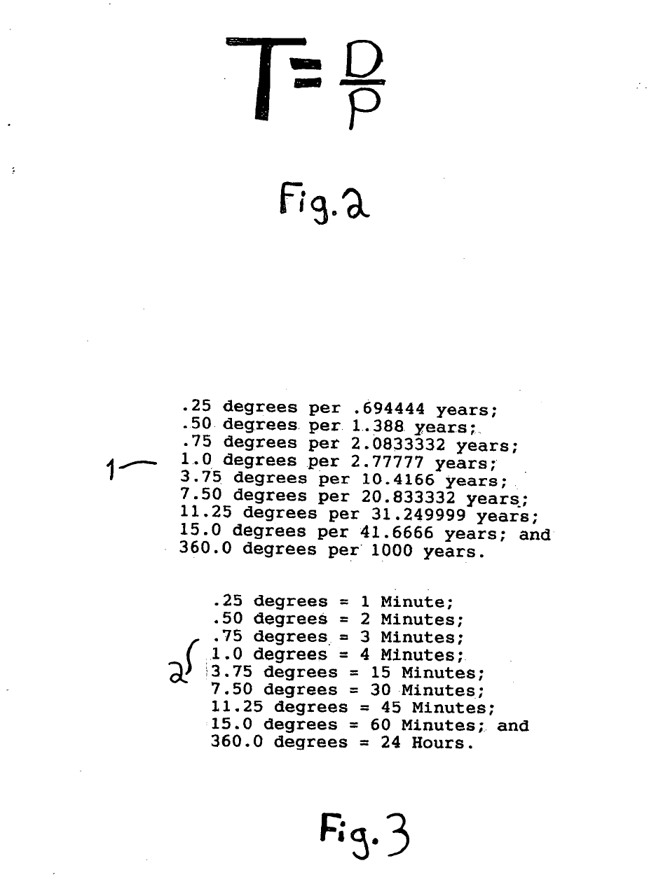

FIG. 3. is the entire table of degree movement for the LORDS DAY HAND, and Mans DAY HAND;
1. is the LORDS DAY TABLE; and
2. is Mans DAY TABLE.

1. I claim; the method of process. mathematical formula, and mathematical tables for metering the time differential between the LORDS DAY vs Mans Day as shown, and described.
I claim: The formula T=D/P, and the tables aforementioned in the specification as elements in combination, and as a method of process, and a means, or step for performing the specified function of metering the time differential between the LORDS DAY vs mans day.
